(19) United States
(12) Patent Application Publication
(10) Pub. No.: US 2011/0301509 A1
(43) Pub. Date: Dec. 8, 2011

(54) Range of Motion Assistant

(75) Inventor: Stephen Lynn Culver, Midland, TX (US)

(73) Assignee: Stephen Lynn Culver, Midland, TX (US)

(21) Appl. No.: 13/192,351

(22) Filed: Jul. 27, 2011

(51) Int. Cl. A61H 1/00

(52) U.S. Cl. 601/5

(57) ABSTRACT

A passive therapy device to facilitate range-of-motion in the human hand, wrist, and/or forearm after surgery, trauma, arthritic complications, rehabilitative therapy, or other events that resulted in limited wrist motion or stiffness. This device facilitates the therapy by utilizing gravity and leverage. Comprised of two modified isosceles triangular rigid sides separated by and narrowing to a point by means of a sandwiched wedge, and a boot and strap comprised of a strong, yet soft material on the outside of one of said rigid sides. This device provides therapy to restricted tissue in the human hand, wrist, and forearm while applying passive tension during rehabilitation. Readily converting from supination/pronation therapy to extension/flexion therapy, and radial/ulnar deviation, the device can also be used on the right or left hand. This invention provides a low cost, simple to use rehabilitation device.

A passive therapy device designed to facilitate range-of-motion in the human hand, wrist, or forearm after surgery, trauma, arthritic complications, rehabilitative therapy, or other events that result in limited wrist motion or stiffness. This device assists in the therapy by utilizing gravity and leverage. Due to the design, the patient and/or therapist can control comfort level and the amount of stretching by simply adjusting the position of the hand of the user. The only moving parts involved are human.

Rigid sides comprised of two modified isosceles triangles separated by and narrowing to a point by means of a sandwiched solid wedge, and a boot comprised of a strong yet soft material strap on the outside of one of the rigid sides. This device provides therapy to restricted tissue in the hand, wrist, and forearm by applying passive tension during rehabilitation. Claim 1 regards supination and pronation.

Supination (palm facing up) is achieved by placing the hand between the rigid sides into the open-end of the device, palm up. The patient then gently rests the smaller pivot end in his/her lap. The amount of torque applied is a direct result of the amount of stiffness involved. The patient experiences a pleasant gentle stretching of the soft tissue involved. Supination is illustrated in FIG. 4.

The scenario described in the previous paragraph applies also to pronation. The only difference is the user rotates the smaller pivot end in the opposite direction of the supination movement to provide stretching of the soft tissue towards a goal of pronation (palm facing down) illustrated in FIG. 5.

In addition to readily converting from supination/pronation therapy to extension/flexion therapy and radial/ulnar deviation, the device can also be used on the right or left hand. Claim 2 regards extension and flexion of the wrist. To achieve soft tissue stretching for flexion and extension, the soft upper boot and strap are utilized. The patient places the hand palm down into the boot and strap. The smaller pivot end is then gently and slowly lifted or lowered creating a slight torque on the wrist in the desired direction. Extension and flexion are illustrated in FIGS. 6 and 7 respectively.

Claim 3 regards radial/ulnar deviation. To achieve soft tissue stretching for radial/ulnar deviation, the soft upper boot and strap are utilized. The patient places the hand palm down into the boot and strap. The smaller pivot end is then gently and slowly moved directionally right and left creating a slight torque in the desired direction. Radial/ulnar deviation is illustrated in FIG. 8.

### BACKGROUND

On Jan. 8, 2011, I fell 15 feet onto a hard surface. Among the numerous broken bones were multiple compound fractures in my left wrist. Once the bones healed it was suggested by my doctor to begin therapy. Initially the goal was supination/pronation and later flexion/extension and radial/ulnar deviation. The method suggested to achieve this goal was to hold a hammer by the affected hand, furthest from the hammer's head and allow the weight of the hammer to stretch the soft tissue by means of gravity. This did not work very well. The handle of the hammer was difficult to hold. I thought there must be a better way. The better way, which I personally invented, is the device for which I am seeking patent protection. During a USPTO search, I found numerous other inventions with similar claims to improve range of motion such as Hepburn et al U.S. Pat. No. 6,740,051, Doran U.S. Pat. No. 6,179799, and Bennett U.S. Pat. No. 6,443,874 to name a few. Most inventions I found were complicated, cumbersome, or cost prohibitive. I believe my invention overcomes those obstacles as well as offering additional therapeutic features.

### BRIEF DESCRIPTION OF THE DRAWINGS

FIG. 1 Perspective view of the range of motion assistant device
1. Wrist strap used for flexion/extension and radial/ulnar deviation
2. Hand boot used for flexion/extension and radial/ulnar deviation
3. Separating wedge
4. Top rigid modified isosceles triangle
5. Pivot end
6. Bottom rigid modified isosceles triangle
7. Open end used for supination/pronation

FIG. 2 Top view of the range of motion assistant device

FIG. 3 Bottom view of the range of motion assistant device

FIG. 4 Usage view; dotted lines represent use to improve supination, arrows represent movement

FIG. 5 Usage view; dotted lines represent use to improve pronation, arrows represent movement

FIG. 6 Usage view; dotted lines represent use to improve extension, arrows represent movement

FIG. 7 Usage view; dotted lines represent use to improve flexion, arrows represent movement

FIG. 8 Usage view; dotted lines represent usage for radial/ulnar deviation, arrows represent movement

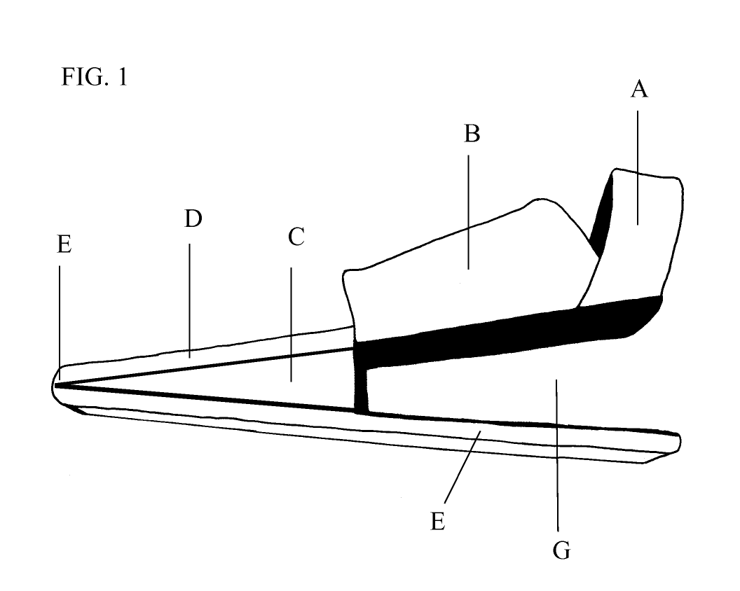

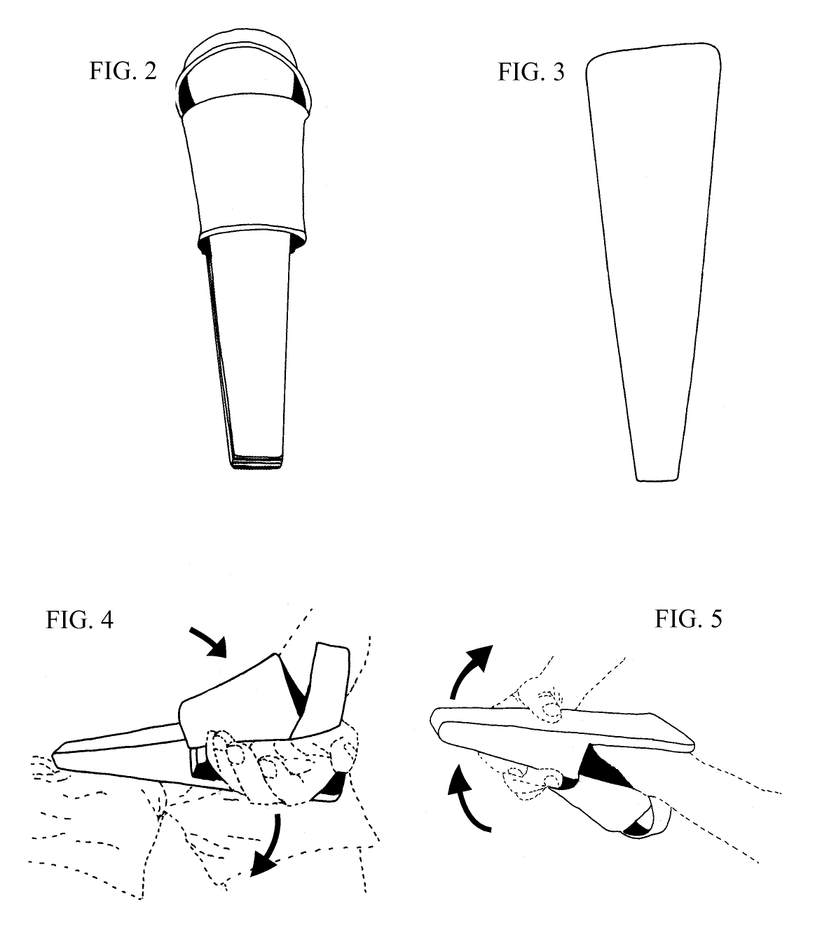

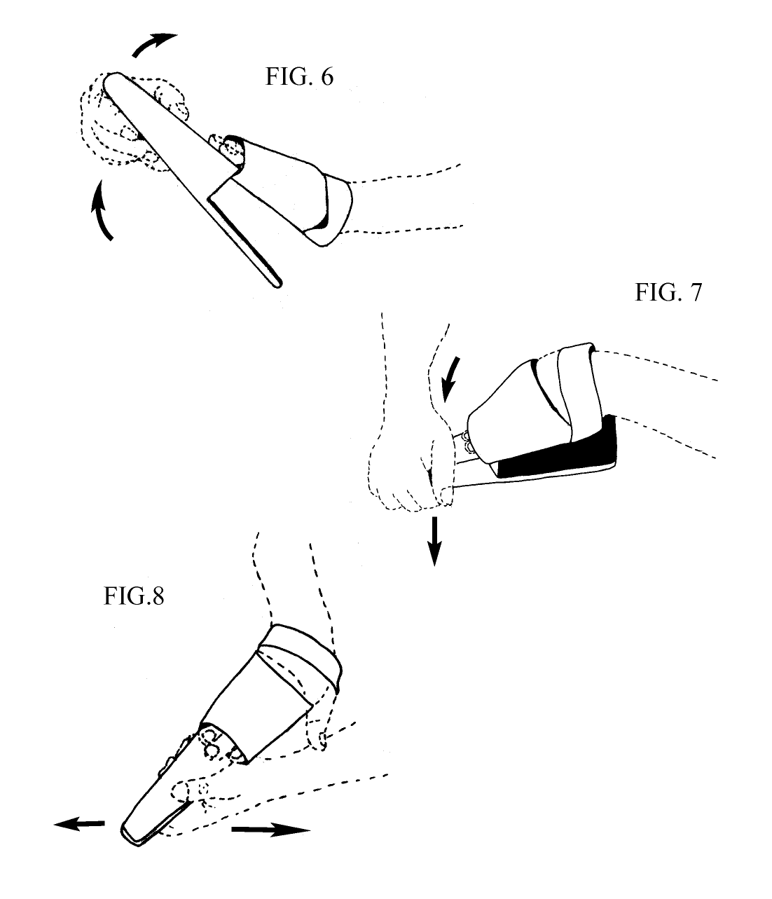

What is claimed:

1. A passive therapy device for use by a human to bring mobility to the hand, wrist, or forearm utilizes two rigid sides as a leverage instrument when a human palm is placed flat inside allowing gravity and/or human interaction to create torque in the desired direction therefore stretching soft tissue assisting in pronation and supination providing improved range of motion and mobility.

2. The soft material boot of this invention works as a second leverage instrument when a human hand placed inside the boot utilizes the entire device to create the desired direction of torque stretching the soft tissue to achieve flexion and extension providing improved range of motion and mobility.

3. The soft material boot of this invention works as a third leverage instrument when a human hand placed inside the boot utilizes the entire device to create the desired direction of torque stretching the soft tissue to achieve radial/ulnar deviation providing improved range of motion and mobility.
